(19) United States
(12) Patent Application Publication
(10) Pub. No.: US 2020/0368894 A1
(43) Pub. Date: Nov. 26, 2020

(54) ACTION ROBOT

(71) Applicant: LG ELECTRONICS INC., Seoul (KR)

(72) Inventors: Jaecheon SA, Seoul (KR); Youngeun KIM, Seoul (KR); Namjin KIM, Seoul (KR); Jideok KIM, Seoul (KR); Sanghun KIM, Seoul (KR)

(73) Assignee: LG ELECTRONICS INC., Seoul (KR)

(21) Appl. No.: 16/833,010

(22) Filed: Mar. 27, 2020

(30) Foreign Application Priority Data
May 21, 2019 (KR) PCT/KR2019/006081

(51) Int. Cl. B25J 9/00; B25J 11/00; B25J 9/12

(52) U.S. Cl. CPC B25J 9/0009; B25J 9/12; B25J 11/003

(57) ABSTRACT

An action robot includes a figure having at least one movable part, a figure base supporting the at least one movable part at a lower side, a pusher embedded into the figure base to pass through an upper surface of the figure base and pushing the at least movable part in a first direction, an elastic member providing a second elastic force to the pusher, a lifter disposed under the figure base, and a load member raised by the lifter and pressurizing the pusher in the first direction.

### CROSS-REFERENCE TO RELATED APPLICATIONS

This application claims the benefit of the Patent Application No. PCT/KR2019/006081 filed in the Republic of Korea on May 21, 2019, which is hereby incorporated by reference as if fully set forth herein.

### BACKGROUND

The present disclosure relates to an action robot, and more particularly, to an action robot including at least one joint.

As robot technology advances, a method of modularizing joints or wheels to manufacture a robot is being used. For example, various types of robots such as puppies, dinosaurs, humans, and spiders may be manufactured by electrically and mechanically connecting and assembling a plurality of actuator modules configuring a robot.

A robot capable of being manufactured by assembling a plurality of actuator modules is generally referred to as a modular robot. Each actuator module configuring a modular robot includes a motor, and thus, a motion of a robot is performed based on a rotation of the motor. Such a motion of a robot is a concept which denotes motions of a robot such as an action and dance.

Recently, robots for entertainments are attracting much attention, and thus, interest in robots for arousing the interest of persons or recreation is increasing. For example, technologies for allowing a user to dance according to music or take a motion or expression according to story (children's story and the like) are being developed.

This denotes that a plurality of motions based on music or children's story are previously set, and when the music or the children's story is reproduced by an external device, an action robot performs a motion by executing a motion previously set based thereon.

### SUMMARY

An aspect of the present disclosure is directed to providing an action robot for implementing movement of a movable part disposed on a figure base independently from a joint rotated by a wire.

To achieve these and other advantages and in accordance with the purpose of the disclosure, as embodied and broadly described herein, there is provided an action robot including: a figure including at least one movable part; a figure base configured to support the at least one movable part at a lower side; a pusher embedded into the figure base to pass through an upper surface of the figure base and to upward push the at least movable part; an elastic member configured to provide a downward elastic force to the pusher; a lifter disposed under the figure base; and a load raised by the lifter and configured to upward pressurize the pusher.

The pusher may include: a pressurized part upward pressurized by the load; a pressurizer configured to upward push the at least one movable part; and a connection part configured to connect the pressurized part to the pressurizer.

The pressurized part may be more adjacent to an outer perimeter of the figure base than the pressurizer.

The connection part may be provided to be inclined in a direction in which a height increases in a direction from the pressurized part to the pressurizer.

The connection part may include: an inclined portion connected to the pressurized part to have a height which increases in a direction distancing from the pressurized part; an extension portion horizontally extending from an end portion of the inclined portion; and a protrusion portion connected to the pressurizer to laterally protrude from the extension portion.

A pusher guide part vertically protruding from an inner surface of the figure base may be provided in the figure base, and a guide hole through which the pusher guide part passes may be provided in the extension portion.

An elastic member pressurizer upward pressurizing the elastic member may be provided in the inclined portion.

An elastic member supporting part vertically protruding from an inner surface of the figure base may be provided in the figure base, and the elastic member may surround an outer perimeter of the elastic member supporting part.

The elastic member supporting part may pass through the elastic member pressurizer.

A load through hole through which the load passes may be provided in a top surface of the figure base.

A through hole through which the pressurizer passes may be provided in a top surface of the figure base.

The figure base may include: a lower plate disposed under the pusher: and a base cover configured to cover the lower plate and the pusher at an upper side.

The figure may include: a body; and an inner frame disposed in the body and connected to the at least one movable part.

A connection shaft rotatably connected to the inner frame may be provided in the at least one movable part.

An inserting groove disposed in one side of the connection shaft and recessed upward from a lower surface of the at least one movable part may be provided in the at least one movable part, and a portion of the pusher may be inserted into the inserting groove.

The lower surface of the at least one movable part may contact the upper surface of the figure base, and an inclined portion disposed at the other side of the connection shaft and on the lower surface of the at least one movable part and spaced apart from the upper surface of the figure base may be provided in the at least one movable part.

In another aspect of the present disclosure, there is provided an action robot including: a figure including a plurality of movable parts: a figure base configured to support the plurality of movable parts at a lower side; a pusher embedded into the figure base to pass through an upper surface of the figure base and to upward push the plurality of movable parts; a motor disposed under the figure base; a horizontal shaft disposed under the figure base; a plurality of cams connected to the horizontal shaft; and a plurality of loads respectively pressurized upward by the plurality of cams and configured to upward push the pusher.

The plurality of cams may be fastened to the horizontal shaft in different directions.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 is a perspective view of an action robot according to an embodiment;

FIG. 2 is an exploded perspective view of an action robot according to an embodiment;

FIG. 3 is a diagram when a figure module according to an embodiment is seen from a rear region;

FIG. 4 is an exploded perspective view of a figure module according to an embodiment;

FIG. 5 is a perspective view of an inner frame and an inner cover body according to an embodiment:

FIG. 6 is a diagram when an inner frame and an inner cover body according to an embodiment are seen from a rear region;

FIG. 7 is a cross-sectional view illustrating the inside of a figure according to an embodiment;

FIG. 8 is a bottom view of a figure according to an embodiment;

FIG. 9 is a diagram illustrating an inner portion of a foot according to an embodiment;

FIG. 10 is a diagram when the inside of a figure according to an embodiment is seen from a front region;

FIG. 11 is a diagram when the inside of a figure according to an embodiment is seen from a rear region;

FIGS. 12A and 12B are diagrams for describing an action where a wire according to an embodiment is pulled;

FIG. 13 is a diagram illustrating an example where a base cover is removed from a figure base according to an embodiment;

FIG. 14 is a plan view of a base cover according to an embodiment;

FIG. 15 is a cross-sectional view illustrating an inner portion of a figure base according to an embodiment;

FIG. 16 is a bottom view of a figure base according to an embodiment;

FIG. 17 is a perspective view of a driving module according to an embodiment;

FIG. 18 is an exploded perspective view of a driving module according to an embodiment;

FIG. 19 is a cross-sectional view illustrating an inner portion of a driving module according to an embodiment;

FIG. 20 is a cut perspective view for describing a driving mechanism pulling a wire according to an embodiment; and

FIG. 21 is a diagram for describing an action where a pusher according to another embodiment is pressurized upward.

### DETAILED DESCRIPTION OF THE DISCLOSURE

Hereinafter, detailed embodiments will be described in detail with reference to the accompanying drawings.

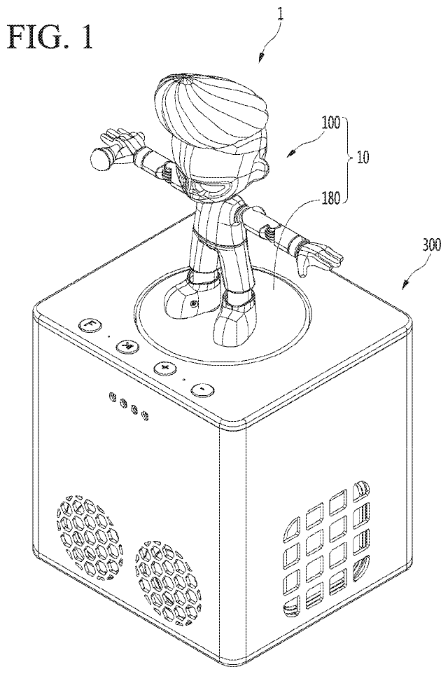

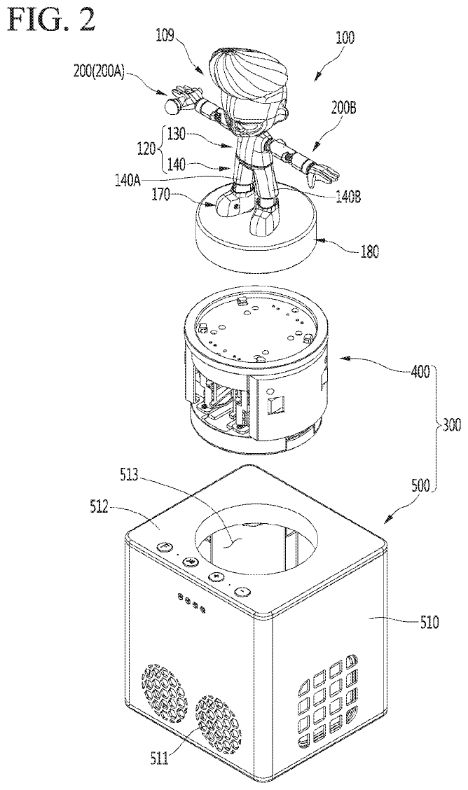

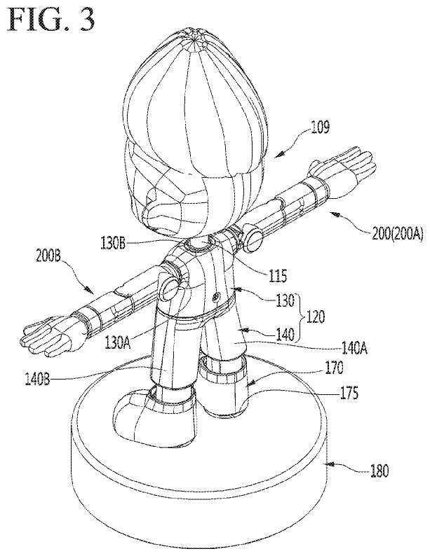

FIG. 1 is a perspective view of an action robot 1 according to an embodiment, FIG. 2 is an exploded perspective view of an action robot according to an embodiment, and FIG. 3 is a diagram when a figure module according to an embodiment is seen from a rear region.

The action robot 1 according to an embodiment may include a figure module 10 and a base module which supports the figure module at a lower side.

The figure module 10 may include a figure 100 and a figure base 180 which supports the figure 100 at a lower side.

The figure 100 may have a shape similar to that of a human body. However, the present disclosure is not limited thereto, and the figure 100 may have a shape of an animal or the like.

The figure 100 may include a head unit 109, a body 120, a movable assembler 200, and a foot 170. Herein, an example where the figure 100 has a shape of a person will be described. Hereinafter, therefore, the movable assembler 200 may be referred to as an arm assembler 200.

The head unit 109 may have a shape corresponding to a head of a person. The head unit 109 may be connected to an upper side of the body 120. The head unit 109 may include a supporting bar 115 connected to the body 120. The supporting bar 115 may correspond to a neck of a human body.

The body 120 may have a shape corresponding to a human body. The body 120 may be fixed and may not move. A space where various components are embedded may be provided in the body 120.

The body 120 may include an upper body 130 and a lower body 140.

An internal space of the upper body 130 may communicate with an internal space of the lower body 140.

The upper body 130 may have a shape corresponding to an upper half of a human body. The arm assembler 200 may be connected to the upper body 130. An arm assembly connection hole 130A connected to the arm assembler 200 may be provided in both sides of the upper body 130.

Moreover, a head connection hole 130B connected to the head unit 109 may be provided in an upper portion of the upper body 130. The supporting bar 115 may pass through the head connection hole 130B.

The lower body 140 may have a shape corresponding to a lower half of a human body. The lower body 140 may include a pair of legs 140A and 140B.

The upper body 130 and the lower body 140 may be detachably fastened to each other. Therefore, an assembly of the body 130 may be simplified, and moreover, components disposed in the body 130 may be easily maintained.

The arm assembly 200 may be connected to both sides of the body 120. In more detail, a pair of arm assemblies 200 may be respectively connected to both sides of the upper body 130.

The pair of arm assemblies 200 may include a right arm assembly 200A corresponding to a right arm of a person and a left arm assembly 200B corresponding to a left arm of a person. Each of the right arm assembly 200A and the left arm assembly 200B may independently move.

The arm assembly 200 may be rotate with respect to the body 120.

The foot 170 may be connected to a lower portion of the lower body 140, namely, a lower portion of each of the pair of legs 140A and 140B. The foot 170 may be supported by the figure base 180.

A portion of a lower end of the foot 170 may be spaced apart from an upper surface of the figure base 180 to provide an inclined portion 175 which forms a certain interval. The inclined portion 175 may be provided at a rear lower end of the foot 170. Accordingly, the foot 170 may move while nodding with respect to the figure base 180.

The figure base 180 may support the foot 170 at a lower side. The figure base 180 may be fastened to the base module 300 at an upper side of the base module 300.

The figure base 180 may have an approximately cylindrical hollow shape.

The base module 300 may support the figure module 10 at a lower side. In more detail, the base module 300 may support the figure base 180 at a lower side.

The figure base 180 may be detachably fastened to the base module 300.

The base module 300 may include a driving module 400 and a sound module 500.

The driving module 400 may be disposed under the figure module 10. The driving module 400 may be fastened to the figure module 10, and in more detail, may be fastened to the figure base 180.

The driving module 400 may be embedded into the sound module 500.

The driving module 400 may drive the figure module 10. The driving module 400 may include a controller which controls an overall operation of the figure module 10 and a driving mechanism which operates the figure module 10, and the controller and the driving mechanism may be embedded into the driving module 400.

The sound module 500 may configure an external appearance of the base module 300.

The sound module 500 may include a housing 510, a top cover 512, and a speaker (not shown).

The housing 510 may have a box shape where an upper surface thereof is approximately opened. The driving module 400 may be disposed in the housing 510.

The top cover 512 may cover the opened upper surface of the housing 510.

An open hole 513 which an upper portion and a lower portion thereof are opened may be provided in the top cover 512. The figure base 180 may be disposed in the open hole 513. That is, a size and a shape of the open hole 513 may correspond to the figure base 180. The open hole 513 may have a size which allows the driving module not to pass through the open hole 513.

The speaker may be embedded into the housing 510. A plurality of sound holes 511 through which a sound of the speaker is discharged may be provided in the housing 510.

The figure 100 may move according to a sound output from the speaker of the sound module 500. The figure 100 may be set to perform an action which differs for each sound output from the speaker.

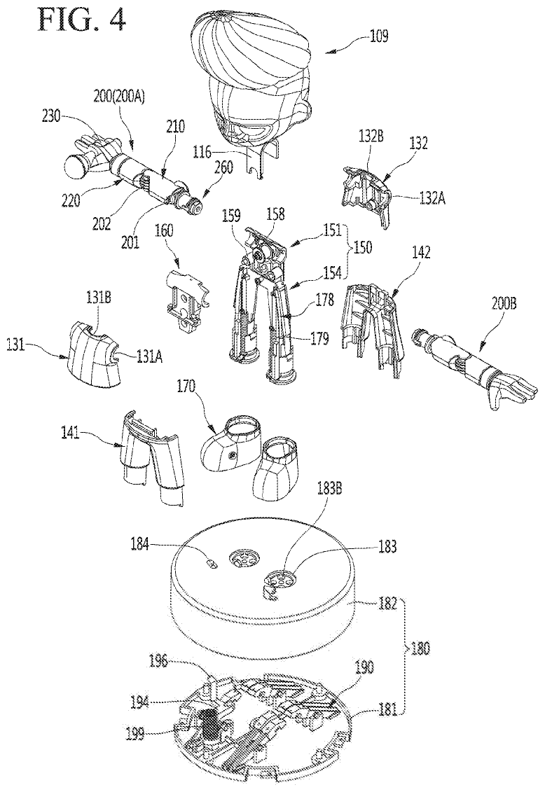

FIG. 4 is an exploded perspective view of a figure module according to an embodiment.

At least one of the upper body 130 and the lower body 140 of the figure 100 may include a front body 131 and 141 and a rear body 132 and 142 which is detachably fastened to a rear portion of the front body 131 and 141.

For example, the upper body 130 may include a front upper body 131 and a rear upper body 132 which are fastened to each other so as to be detached from each other in a forward-rearward direction. An internal space of the upper body 130 may be provided between the front upper body 131 and the rear upper body 132. Also, the lower body 140 may include a front lower body 141 and a rear lower body 142 which are fastened to each other so as to be detached from each other in a forward-rearward direction. An internal space of the lower body 140 may be provided between the front lower body 141 and the rear lower body 142.

A first arm assembly connection groove 131A may be provided in both sides of the front upper body 131, and a second arm assembly connection groove 132A may be provided in both sides of the rear upper body 132. When the front upper body 131 and the rear upper body 132 are fastened to each other, the first arm assembly connection groove 131A and the second arm assembly connection groove 132A may form an arm assembly connection hole 130A (see FIG. 3) together.

A first head connection groove 131B may be provided in an upper portion of the front upper body 131, and a second head connection groove 132B may be provided in an upper portion of the rear upper body 132. When the front upper body 131 and the rear upper body 132 are fastened to each other, the first head connection groove 131B and the second head connection groove 132B may form a head connection hole 130B (see FIG. 3) together.

The head 30 may include a head fixing part 116 which is fastened to at least one of an inner frame 150 and an inner cover body 160 to be described below. The head fixing part 116 may be disposed in the upper body 130. In more detail, the head fixing part 116 may be disposed between the front upper body 131 and the rear upper body 132.

The head fixing part 116 may be provided as one body with a supporting bar 115 (see FIG. 3) of the head unit 109, or may be fastened to the supporting bar 115. Therefore, the head unit 109 may be solidly fastened to the body 130.

The arm assembly 200 may include an upper arm part 210, a lower arm part 220, and a hand part 230. Also, the arm assembly 200 may include at least one joint 201 and 202. In more detail, the arm assembly 200 may include a shoulder joint 201 and an elbow joint 202.

Since the arm assembly 200 includes at least one joint 201 and 202, the arm assembly 200 may implement various operations. That is, the upper arm part 210 and the lower arm part 220 may each be a movable part which moves by using the joint 201 and 202.

The upper arm part 210 may correspond to a portion between a shoulder and an elbow in an arm of a person. The lower arm part 220 may correspond to a portion between an elbow and a wrist in an arm of a person. The hand part 230 may correspond to a hand and a wrist of a person.

The shoulder joint 201 may rotate the upper arm part 210 with respect to the body 120. The upper arm part 210 may rotate based on the shoulder joint 201 to open or close an armpit.

The elbow joint 202 may rotate the lower arm part 202 with respect to the upper arm part 210. The lower arm part 220 may rotate based on the elbow joint 202 to fold or unfold an elbow.

The arm assembly 200 may further include a connector 260 connected to the body 120. The connector 260 may connect the shoulder joint 201 to the body 120.

The connector 260 may be rotatably connected to the body 120. That is, the connector 260 may rotate the shoulder joint 201 and the upper arm part 210 with respect to the body 120. In this case, a rotational shaft of the connector 260 may be vertical to a rotational shaft of the shoulder joint 201. In more detail, the rotational shaft of the shoulder joint 201 may be provided long in a forward-rearward direction, and the rotational shaft of the connector 260 may be provided long in a left-right direction.

An operation where a whole portion of the arm assembly 200 rotates based on the connector 260 to turn an arm may be performed.

The right arm assembly 200A and the left arm assembly 200B may have the same configuration.

The figure 100 may further include the inner frame 150. The inner frame 150 may be disposed in the body 120.

The inner frame 150 may perform a function of a frame of the figure 100.

The inner frame 150 may support the head unit 109 and the arm assembly 200.

The inner frame 150 may include a body frame 151 of which at least a portion is disposed in the upper body 130 and a pair of leg frames 154 of which at least a portion is disposed in the lower body 140 and which is connected to the body frame 151.

The body frame 151 and the leg frame 154 may be provided as one body. However, the present disclosure is not limited thereto.

A lower end of the leg frame 154 may be fastened to the figure base 180. The foot 170 may surround a portion of a lower side of the leg frame 154.

A detailed configuration of the inner frame 70 will be described below in detail.

The figure 100 may further include a tube 178. The tube 178 may be disposed in the body 120, and in more detail, may be disposed in the lower body 140. The tube 178 may be equipped in the inner frame 150. In more detail, the tube 178 may be equipped in the leg frame 154.

The tube 178 may be disposed long in an upward-downward direction.

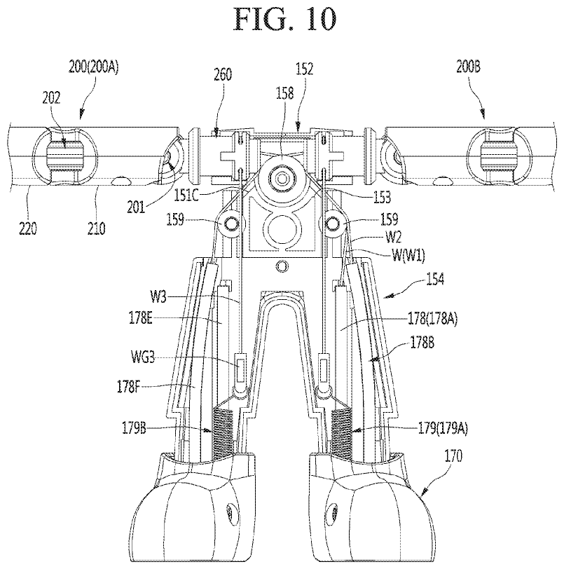

The tube 178 may include a flexible material. Therefore, the tube 178 may be easily equipped in the leg frame 154 with being bent. The tube 178 may guide a wire W (see FIG. 10) which drives the figure 100. The wire W will be described below in detail.

The tube 1768 may be provided in plurality. Each of the plurality of tubes 178 may guide one wire W.

The figure 100 may further include an elastic member 179. The elastic member 179 may be disposed in the body 120, and in more detail, may be disposed in the lower body 140. The elastic member 179 may be equipped in the inner frame 150. In more detail, the elastic member 179 may be equipped in the leg frame 154.

The elastic member 179 may be a coil spring. The elastic member 179 may be disposed long in a vertical direction. The elastic member 179 may be disposed to surround a portion of a lower portion of an outer perimeter of the tube 178.

The elastic member 179 may be connected to a wire W3 (see FIG. 10) which rotates the connector 260 of the arm assembly 200. This will be described below in detail.

The figure 100 may further include a plurality of wire supporters 158 and 158.

The wire supporters 158 and 159 may support the wire. In more detail, the wire W passing through the tube 178 may contact the wire supporters 158 and 159. Therefore, the wire W may be tightly maintained by a tension.

The wire supporters 158 and 159 may be equipped in the inner frame 150. The wire supporters 158 and 159 may be equipped in a front portion of the inner frame 150.

In more detail, the wire supporters 158 and 159 may be mounted on the body frame 151. The wire supporters 158 and 159 may be fixed to the inner frame 150, or may be rotatably equipped in the inner frame 150.

The wire supporters 158 and 159 may each have an approximately cylindrical hollow shape. The wire supporters 158 and 159 may be provided long in a forward-rearward direction.

The wire supporters 158 and 159 may include a main supporter 158 and a sub-supporter 159. The sub-supporter 159 may be provided as a pair of sub-supporters which are spaced apart from each other in a horizontal direction.

A diameter of the main supporter 158 may be greater than that of the sub-supporter 159.

The main supporter 158 may be disposed more upward from the sub-supporter 159. That is, a vertical distance from an upper end of the inner frame 150 to the main supporter may be shorter than a vertical distance from an upper end of the inner frame to the sub-supporter.

With respect to a horizontal direction, the main supporter 158 may be provided at a center portion of the inner frame 150, and the sub-supporter 159 may be provided at a side portion of the inner frame 150.

The figure 100 may further include an inner cover body 160.

The inner cover body 160 may be fastened to the inner frame 150. The inner cover body 160 may be fastened to the inner frame 150, and in more detail, may be fastened to a front portion of the body frame 151.

The inner cover body 160 may prevent the wire supporters 158 and 159 equipped in the inner frame 150 from deviating therefrom in a forward direction.

The inner cover body 160 may be disposed in the body 120. The inner cover body 160 may be disposed between the inner frame 150 and the front upper body 131.

The inner cover body 160 may support the head unit 109 and the arm assembly 200 along with the inner frame 150.

The figure base 180 may include a lower plate 181 and a base cover 182.

The lower plate 181 may have an approximately discal shape (i.e., disk shape). The lower plate 181 may configure a lower surface of the figure base 180.

The base cover 182 may include an internal space provided therein, and the lower surface thereof may be open. The base cover 182 may cover the lower plate 181 at a lower side. The base cover 182 may configure a perimeter surface and an upper surface of the figure base 180.

A fastening groove 183 to which inner frame 150 (in more detail, a lower end of the leg frame 154) is fastened may be provided in an upper surface of the base cover 182. The fastening groove 183 may be provided as an upper surface of the base cover 182 is recessed downward.

A plurality of power transferors 190 and 194 for transferring a driving force of the driving module 400 to the figure 100 may be embedded into the figure base 180.

The plurality of power transferors 190 and 194 may include at least one of a seesaw lever 190 and a pusher 194. Hereinafter, a case where all of the seesaw lever 190 and the pusher 194 are embedded into the figure base 180 will be described for example.

At least one seesaw lever 190 may be embedded into the figure base 180. The seesaw lever 190 may be disposed on the lower plate 181 and may be covered by the base cover 182.

Each of each seesaw lever 190 may operate like seesaw. That is, when one end portion of the seesaw lever 190 is lowered, the other end portion thereof may be raised, and when the one end portion of the seesaw lever 190 is raised, the other end portion thereof may be lowered.

The wire W (see FIG. 10) may be connected to the one end portion of the seesaw lever 190. The other end portion of the seesaw lever 190 may be raised by the above-described driving module 400. Therefore, the one end portion of the seesaw lever 190 connected to the wire W may be lowered and may pull the wire W, thereby driving the figure 100.

A wire through hole 183B through which the wire W connected to the one end portion of the seesaw lever 190 passes may be provided in the upper surface of the base cover 182. The wire through hole 183B may be provided in the fastening groove 183.

The wire W connected to the seesaw lever 190 may extend to the inside of the tube 178 which passes through the wire through hole 183B and is mounted on the inner frame 150.

The pusher 194 which upward pushes the foot 170 may be embedded into the figure base 180. The pusher 194 may be disposed on the lower plate 181 and may be covered by the base cover 182.

The pusher may be upward pressurized by the above-described driving module 400. Also, an inner elastic member 199 which provides a downward elastic force to the pusher 194 may be included in the figure base 180.

A through hole 184 through which the pusher 194 protrudes upward may be provided in the upper surface of the base cover 182. A portion of the pusher 194 may protrude to an upper side through the through hole 184 and may push the foot 170. Accordingly, a motion where the foot 170 nods the foot may be implemented.

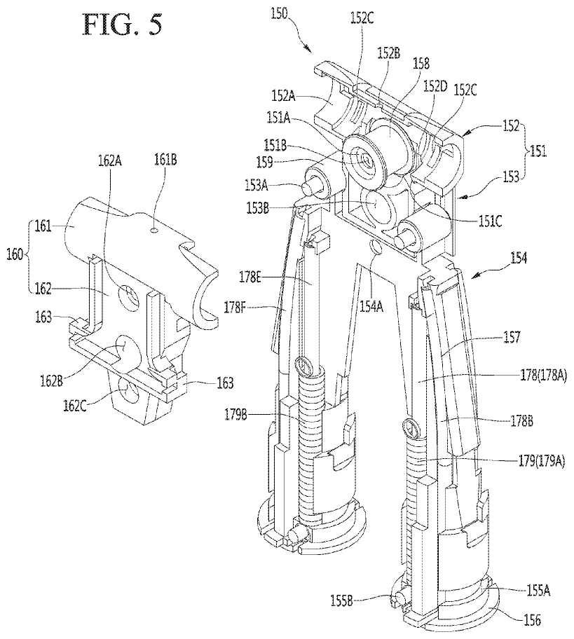

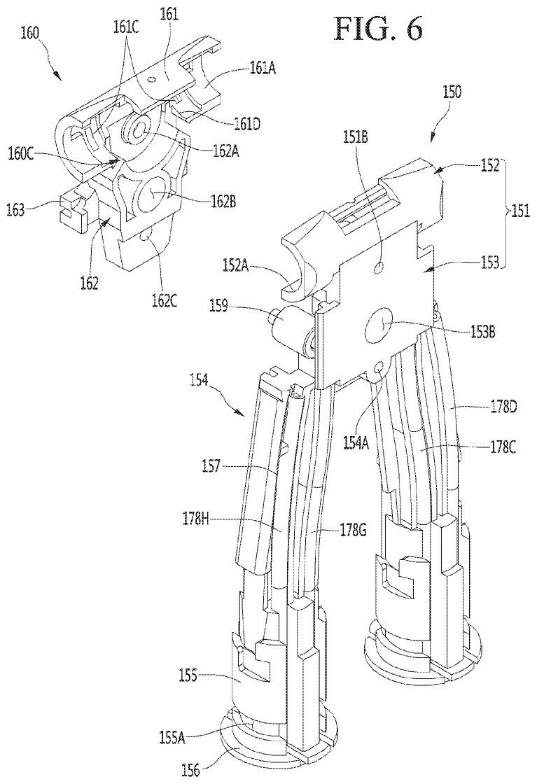

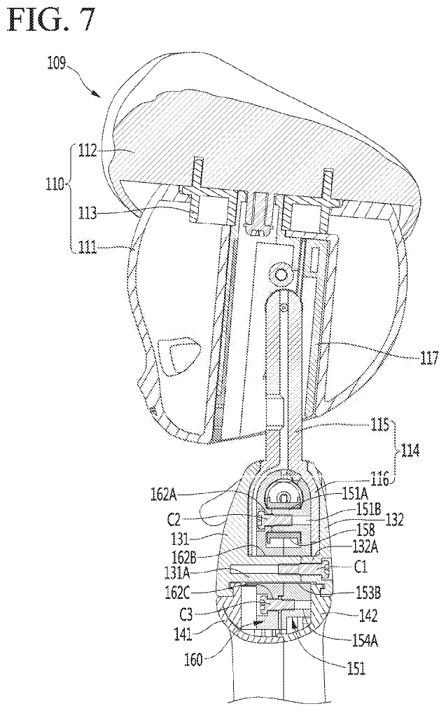

FIG. 5 is a perspective view of an inner frame and an inner cover body according to an embodiment, FIG. 6 is a diagram when an inner frame and an inner cover body according to an embodiment are seen from a rear region, and FIG. 7 is a cross-sectional view illustrating the inside of a figure according to an embodiment.

As described above, an inner frame 150 may include the body frame 151 and the pair of leg frames 154 connected to a lower portion of the body frame 151.

A main supporter mounting part 151A with the main supporter 158 mounted thereon may be provided in the body frame 151. The main supporter mounting part 151A may protrude in a forward direction from the body frame 151. The main supporter mounting part 151A may be inserted into a hollow portion provided in the main supporter 158.

The body frame 151 may include an upper frame 152 and a lower frame 153 connecting the upper frame 152 to the leg frame 154.

The upper frame 152 may be provided long in a horizontal direction. The upper frame 152 may have a shape where an approximately hollow cylinder is cut in a lengthwise direction. A front surface of the upper frame 152 may be open, and a rear surface thereof may be provided to be convex in a rearward direction.

A rear hanging jaw 152A for preventing the arm assembly 200 from deviating therefrom in a horizontal direction may be provided in both end portions of the upper frame 152. The rear hanging jaw 152A may protrude in a radius inward direction from an inner surface of the upper frame 152.

A rear avoidance groove 152D for avoiding interference with the main supporter 158 may be provided in the upper frame 152. The rear avoidance groove 152D may be formed by cutting a center portion of a lower front portion of the upper frame 152.

The lower frame 153 may be disposed between the upper frame 152 and the leg frame 154.

A horizontal length of the lower frame 153 may be shorter than a horizontal length of the upper frame 152.

The upper frame 152, the lower frame 153, and the leg frame 154 may be provided as one body.

A sub-supporter mounting part 153A with the sub-supporter 159 mounted thereon may be provided in the lower frame 153. The sub-supporter mounting part 153A may protrude in a forward direction from the lower frame 153. The sub-supporter mounting part 153A may be inserted into a hollow portion provided in the sub-supporter 159.

The leg frame 154 may be provided long in a vertical direction. The leg frame 154 may be provided as a pair of leg frames 154.

A plurality of fitting grooves 157 on which the tube 178 is mounted may be provided in the leg frame 154. Each of the fitting grooves 157 may be provided long in a vertical direction. The fitting groove 157 may be provided to be bent, and the tube 178 may be bent and fitted to match a shape of the fitting groove 157. However, the present disclosure is not limited thereto, and the fitting groove 157 may be vertically provided and the tube 178 may be vertically fitted thereinto without being bent.

Some of the plurality of fitting grooves 157 may be provided in a front portion of the leg frame 154. The other some fitting grooves 157 may be provided in a rear portion of the leg frame 154. That is, some of a plurality of tubes 178 may be mounted on the front portion of the leg frame 154, and the other some thereof may be mounted on the rear portion of the leg frame 154.

For example, the plurality of tubes 178 may include a first tube 178A, a second tube 178B, a third tube 178C, a fourth tube 178D, a fifth tube 178E, a sixth tube 178F, a seventh tube 178G, and an eighth tube 178H.

The first tube 178A and the second tube 178B may be disposed on a front surface of one leg frame 154 (for example, a left leg frame). That is, the first tube 178A and the second tube 178B may be disposed between the one leg frame 154 and the front lower body 141. Also, the first tube 178A may be disposed more inward than the second tube 178B.

The third tube 178C and the fourth tube 178D may be disposed on a rear surface of the other leg frame 154 (for example, a right leg frame). That is, the third tube 178C and the fourth tube 178D may be disposed between the other leg frame 154 and the rear lower body 142. Also, the third tube 178C may be disposed more inward than the fourth tube 178D.

The fifth tube 178E and the sixth tube 178F may be disposed on a front surface of the other leg frame 154. That is, the fifth tube 178E and the sixth tube 178F may be disposed between the other leg frame 154 and the front lower body 141. Also, the fifth tube 178E may be disposed more inward than the sixth tube 178F.

The seventh tube 178G and the eighth tube 178H may be disposed on a rear surface of the one leg frame 154. That is, the seventh tube 178G and the eighth tube 178H may be disposed between the one leg frame 154 and the rear lower body 142. Also, the seventh tube 178G may be disposed more inward than the eighth tube 178H.

A rear hole 152C through which the wire W3 (see FIG. 10) for rotating the connector 260 of the arm assembly 200 passes may be provided in the upper frame 152. The rear hole 152C may be a long hole which is long provided in a diameter direction of the upper frame 152. The rear hole 152C may be provided as a pair of rear holes 152C which are spaced apart from each other in a horizontal direction. The pair of rear holes 152C may be disposed at opposite positions with respect to the main supporter 158.

The wire W3 (see FIG. 10) for rotating the connector 260 of the arm assembly 200 may pass through the tube 178 mounted on a rear portion of the leg frame 154, may pass through the rear hole 152C provided in the upper frame 152, and may be inserted into the upper frame 152.

A rear guide groove 151C which guides wires W1 and W2 (see FIG. 10) for rotating the shoulder joint 201 and the elbow joint 202 of the arm assembly 200 may be provided in the body frame 151. The rear guide groove 151C may be provided between the upper frame 152 and the lower frame 153. The rear guide groove 151C may be provided as a pair of rear guide grooves 151C which are spaced apart from each other in a horizontal direction. The pair of rear guide grooves 151 may be disposed at opposite positions with respect to the main supporter 158.

The wires W1 and W2 (see FIG. 10) for rotating the shoulder joint 201 and the elbow joint 202 of the arm assembly 200 may pass through the tube 178 mounted on the rear portion of the leg frame 154, may pass through the rear guide groove 151C, and may be inserted into the upper frame 152.

A pair of elastic members 179 may be mounted on the leg frame 154. Hereinafter, a case where the elastic member 179 is disposed in front of the leg frame 154 will be described for example, but the present disclosure is not limited thereto.

An upper end of the elastic member 179 may be connected to the wire W3 (see FIG. 10) which rotates the connector 260 of the arm assembly 200, and a lower end thereof may be fixed to the leg frame 154. In more detail, an elastic member fixing part 155B to which a lower end of the elastic member 179 is fixed may be provided under each of the leg frames 154.

Therefore, when a tension is applied to the wire W3, the wire W3 may upward pull the elastic member 179, and the elastic member 179 may extend. When the tension applied to the wire S3 is removed, the elastic member 179 may be contracted by a restoring force of the elastic member 179 and may downward pull the wire W3.

The pair of elastic members 179 may include a first elastic member 179A mounted on the one leg frame 154 and a second elastic member 179B mounted on the other leg frame 154.

The first elastic member 179A may surround a lower outer perimeter of the first tube 178A, and the second elastic member 179B may surround a lower outer perimeter of the fifth tube 178E.

The first elastic member 179A may be connected to the wire W3 which rotates the connector 260 of one arm assembly 200B, and the second elastic member 179B may be connected to the wire W3 which rotates the connector 260 of the other one arm assembly 200A. This will be described below in detail.

A foot connection groove 155A connected to the foot 170 may be provided in a lower portion of the leg frame 154. In more detail, the foot connection groove 155A may be provided long in a perimeter direction of a lower portion of the leg frame 154.

The foot connection groove 155A may be provided in each of a lower outer portion and a lower inner portion of the leg frame 154. The inner portion may denote a portion facing the other one leg frame 154, and the outer portion may denote a portion opposite to the inner portion.

A base fastening part 156 fastened to the figure base 180 may be provided at a lower end portion of the leg frame 154. In more detail, the base fastening part 156 may be inserted into the fastening groove 183 provided in the upper surface of the base cover 182.

The inner frame 160 may be fastened to the inner frame 150 in front of the inner frame 151.

The inner cover body 160 may include an upper cover body 161 and a lower cover body 162. The upper cover body 161 and the lower cover body 162 may be provided as one body.

The upper cover body 161 may be provided long in a horizontal direction. The upper cover body 161 may have a shape where an approximately hollow cylinder is cut in a lengthwise direction. A rear surface of the upper cover body 161 may be open, and a front surface thereof may be provided to be convex in a rearward direction.

The upper body 161 may have a shape approximately symmetrical with the upper frame 152. The upper cover body 161 may be fastened to the upper frame 152 to configure an arm assembly mounting part with the connector 260 of the arm assembly 200 mounted thereon. The arm assembly mounting part may have an approximately hollow cylindrical shape, and the connector 260 of each arm assembly 200 may be mounted on both ends.

A front hanging jaw 161A for preventing the arm assembly 200 from deviating therefrom in a horizontal direction may be provided in both end portions of the upper cover body 161. The front hanging jaw 161A may protrude in a radius inward direction from an inner surface of the upper cover body 161.

The front hanging jaw 161A may be provided at a position corresponding to the rear hanging jaw 152A provided in the upper frame 152. The front hanging jaw 161A may prevent the arm assembly 200 from deviating therefrom in a horizontal direction along with the rear hanging jaw 152A.

A front hole 161C through which the wire W3 (see FIG. 10) for rotating the connector 260 of the arm assembly 200 passes may be provided in the upper cover body 161. The front hole 161C may be a long hole which is long provided in a diameter direction of the upper cover body 161. The front hole 161C may be provided as a pair of front holes 161C which are spaced apart from each other in a horizontal direction. The pair of front holes 161C may be disposed at opposite positions with respect to the main supporter 158.

The front hole 161C may forward and rearward face the rear hole 152C provided in the upper frame 152.

The wire W3 for rotating the connector 260 of the arm assembly 200 may pass through the front hole 161C provided in the upper cover body 161, may be unloaded to the outside of the upper cover body 161, and may be connected to the elastic member 179 mounted on the leg frame 154.

A front guide groove 160C, which guides the wires W1 and W2 (see FIG. 10) for rotating the shoulder joint 201 and the elbow joint 202 of the arm assembly 200, may be provided in the inner cover body 160. The front guide groove 160C may be provided between the upper cover body 161 and the lower cover body 162. The front guide groove 160C may be provided in a pair of front guide grooves 160C which are spaced apart from each other in a horizontal direction. The pair of front guide grooves 160C may be disposed at opposite positions with respect to the main supporter 158.

The wires W1 and W2 (see FIG. 10) for rotating the shoulder joint 201 and the elbow joint 202 of the arm assembly 200 may pass through the tube 178 mounted on a front portion of the leg frame 154, may pass through the front guide groove 160C, and may be inserted into the upper cover body 161.

The front guide groove 160C may communicate with a rear guide groove 150C provided in the body frame 151. The front guide groove 160C may provide a guide hole, through which the wires W1 and W2, along with the rear guide groove 150C.

An upper hole 161B through which the wire W passes may be provided in the upper cover body 161. The upper hole 161B may be provided in order for an upper surface of the upper cover body 161 to upward and downward pass therethrough. One wire W may be connected to the head unit 109 through the upper hole 161B and may drive the head unit 109.

An avoidance groove 152B disposed under the upper hole 161B may be provided in the upper frame 151. The avoidance groove 152B may prevent the wire W passing through the upper hole 161B from interfering with the upper frame 151. Instead of the avoidance groove 152B, an avoidance hole may be provided in the upper frame 161.

A front avoidance groove 161D for avoiding interference with the main supporter 158 may be provided in the upper cover body 161. The front avoidance groove 161D may be formed by cutting a center portion of a lower rear portion of the upper cover body 161.

The front avoidance groove 161D may be provided at a position corresponding to the rear avoidance groove 152D provided in the upper frame 151. The front avoidance groove 161D may configure an open portion, where the main supporter 158 is disposed, along with the rear avoidance groove 152D.

The lower cover body 162 may be connected to a lower portion of the upper cover body 161. The lower cover body 162 may be fastened to the lower frame 153 in front of the lower frame 153.

A horizontal length of the lower cover body 162 may be shorter than a horizontal length of the upper cover body 151.

An anti-deviation part 263 connected to the sub-supporter mounting part 153A provided in the lower frame 153 may be provided at the lower cover body 162. The anti-deviation part 163 may be provided as a pair of anti-deviation parts 163. The anti-deviation parts 163 may protrude from both sides of the lower cover body 162. When the lower cover body 162 is fastened to the lower frame 153, the anti-deviation part 163 may contact a front end portion of the sub-supporter mounting part 153A. Therefore, the anti-deviation part 163 may prevent the sub-supporter 159 mounted on the sub-supporter mounting part 153A from forward deviating therefrom.

Hereinafter, a configuration associated with fastening the inner frame 150 to the inner cover body 160 will be described.

An upper fastening hole 151B may be provided in the main supporter mounting part 151A of the inner frame 150, and an upper through hole 162A corresponding to the upper fastening hole 151B may be provided in the inner cover body 160.

The upper fastening hole 151B may long pass through a region from a front end of the main supporter mounting part 151A to a rear surface of the main frame 150 forward and rearward. The upper through hole 162A may be provided to pass through the inner cover body 160 forward and rearward. A fastening member C2 (see FIG. 7) such as a screw may pass through the upper through hole 162A and may be fastened to the upper fastening hole 151B.

Moreover, a lower fastening hole 154A may be provided in a lower portion of the lower frame 153 of the inner frame 150, and a lower through hole 162C corresponding to the lower fastening hole 154A may be provided in a lower portion of the lower cover body 162.

The lower fastening hole 154A may be disposed more downward than the upper fastening hole 151B, and the lower through hole 162C may be disposed more downward than the upper through hole 162A.

The lower fastening hole 154A may long pass through a lower portion of the lower frame 153 forward and rearward. The lower through hole 162C may be provided to pass through a lower portion of the lower cover body 162 forward and rearward. A fastening member C3 (see FIG. 7) such as a screw may pass through the upper through hole 162C and may be fastened to the lower fastening hole 154A.

Hereinafter, a configuration associated with fastening the front upper body 131 to the rear upper body 132 will be described.

A first hollow portion 131A protruding in a rearward direction may be provided in the front upper body 131, and a second hollow portion 132A protruding in a forward direction may be provided in the rear upper body 132. The first hollow portion 131A and the second hollow portion 132A may be disposed on the same line in a forward-rearward direction. A rear end of the first hollow portion 131A may contact a front end of the second hollow portion 132A. A fastening member C1 such as a screw may pass through one of the first hollow portion 131A and the second hollow portion 132A and may be fastened to the other thereof.

A plurality of avoidance holes 153B and 162B for avoiding interference with at least one of the first hollow portion 131A and the second hollow portion 132A may be provided in the inner frame 150 and the inner cover body 160. In more detail, a rear avoidance hole 153B may be provided to pass through the lower frame 153 of the inner frame 150 forward and rearward. A front avoidance hole 162B corresponding to the rear avoidance hole 153B may be provided to pass through the lower cover body 162 of the inner cover body 160 forward and rearward.

The rear avoidance hole 153B may be disposed between the upper fastening hole 151B and the lower fastening hole 154A in a vertical direction. The front avoidance hole 162B may be disposed between the upper through hole 162A and the lower through hole 162C in a vertical direction.

Hereinafter, a head unit will be described in detail with reference to FIG. 7.

The head unit 109 may include a head 110, a head connector 114, and a head inner frame 117.

The head 110 may be disposed on the body 120.

The head 110 may include a head case 111 and a head cover 112. The head 110 may further include a fastening body 113 which fastens the head case 111 to the head cover 112.

The head case 111 may configure an external appearance of the head 110. The head case 111 may have a shape corresponding to a face and a head of a human body.

The head cover 112 may be fastened to an upper portion of the head case 111. The head cover 112 may have a shape corresponding to a hair style of a human body. In more detail, the fastening body 113 may be fastened to a lower surface of the head cover 112, and the fastening body 113 may be fastened and fixed to the head case 111.

The head connector 114 may be fastened to the body 120. The head connector 114 may connect the head unit 109 to the body 120.

The head connector 114 may include the supporting bar 115 and the head fixing part 116 each described above.

The supporting bar 115 may be provided long in a vertical direction and may correspond to a neck of a human body. The supporting bar 115 may be provided long rom the body 120 to the inside of the head 110.

The head fixing part 116 may be disposed in the body 120. The head fixing part 116 may be connected to a lower end of the supporting bar 115. The head fixing part 116 may be fixed between the body 120 and the inner frame 150 and inner cover body 160.

In more detail, the head fixing part 116 may include a front fixing part connected to a front portion of a lower end of the supporting bar 115 and a rear fixing part connected to a rear portion of the lower end of the supporting bar 115. The front fixing part and the rear fixing part may be spaced apart from each other forward and rearward. The front fixing part may be disposed between the front upper body 131 and the inner cover body 160, and the rear fixing part may be disposed between the rear upper body 132 and the inner frame 150.

The head inner frame 117 may be disposed in the head 110, and in more detail, may be disposed in the head case 111. The head inner frame 117 may include an internal space and a lower surface which is open, and may be provided long in a vertical direction.

At least a portion of the supporting bar 115 may be disposed in the head inner frame 117, and the head inner frame 117 may be connected to the supporting bar 115 so as to be tilted. Also, the head inner frame 117 may be fastened to the head 110. Therefore, the head 110 and the head inner frame 117 may be tilted with respect to the supporting bar 115, and a motion where the figure 100 nods a neck may be implemented.

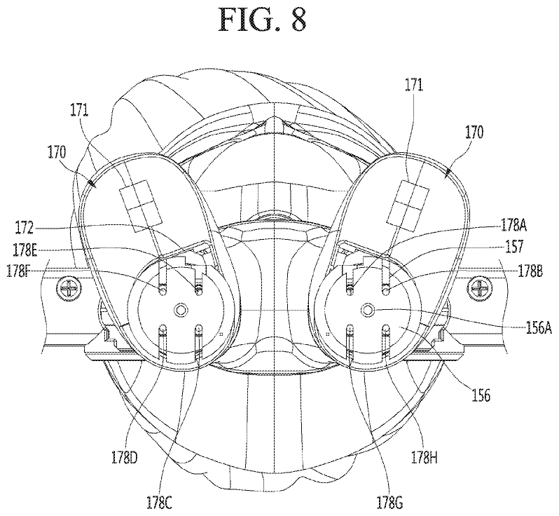

FIG. 8 is a bottom view of a figure according to an embodiment.

The base fastening part 156 provided at a lower end of the leg frame 150 may be disposed under the tube 178.

A base fastening hole 156A fastened to the figure base 180 may be provided in the base fastening part 156. The base fastening hole 156A may be provided at a center portion of the base fastening part 156.

A wire avoidance groove 157 which prevents interference by the wire W (see FIG. 10) entering the inside of the tube 178 may be provided in the base fastening part 156. Instead of the wire avoidance groove 157, a wire avoidance hole may be provided.

A lower end of the tube 178 may face the wire avoidance groove 157. Therefore, the wire W may enter the inside of the tube 178 without interfering with the base fastening part 156.

A plurality of wire avoidance grooves 157 may be provided in each led frame 154. The number of wire avoidance grooves 157 may be the same as the number of tubes 178 mounted on the led frame 154. For example, four wire avoidance grooves 157 may be provided in each leg frame 154.

An inserting groove 171 into which the pusher 194 (see FIG. 4) protruding to a portion on the figure base 180 may be provided in a lower surface of the foot 170. The inserting groove 171 may be provided to be recessed from the lower surface to an upper portion of the foot 170. The inserting groove 171 may be provided at a front portion of the lower surface of the foot 170.

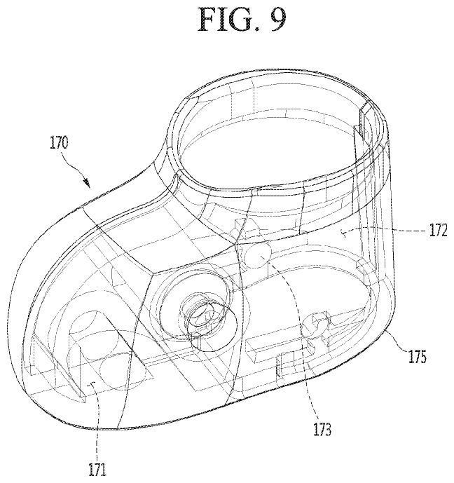

FIG. 9 is a diagram illustrating an inner portion of a foot according to an embodiment.

A foot 170 may be a movable part which moves with respect to a figure base 180 (see FIG. 2).

The foot 170 may be provided by fastening two or more parts separated from one another, and a space may be provided in the foot 170.

An open portion 172 where a lower portion of a leg frame 154 is disposed may be provided in the foot 170. The open portion 172 may denote a portion of a rear region of the internal space of the foot 170. A lower portion of the leg frame 154 may be disposed in the open portion 172, and thus, the foot 170 may surround the lower portion of the leg frame 154.

An inclined portion 175 may be provided in a lower surface of the foot 170. The inclined portion 175 may be provided at a portion (i.e., a rear portion of a lower surface of the foot 170) corresponding to a heel.

The inclined portion 175 may be provided to be inclined in a direction in which a height increases in a direction closer to a rear region. The inclined portion 175 may be apart from an upper surface of the figure base 180.

A connection shaft 173 protruding toward an inner portion of the open portion 172 may be provided in the foot 170. The connection shaft 173 may be rotatably connected to an inner frame 150 (in more detail, the leg frame 154). The connection shaft 173 may protrude toward a foot connection groove 155A (see FIG. 5) provided in the leg frame 154.

In more detail, the connection shaft 173 may protrude from an inner surface of the foot 170 to the foot connection groove 155A. The connection shaft 173 may be provided in plurality. For example, a pair of connection shafts 173 facing each other may be provided on both side surfaces of the inner surface of the foot 170.

The connection shaft 173 may protrude in a horizontal direction. A cross-sectional surface of the connections shaft 173 may have a circular shape. An inserting groove 171 of the foot 170 may be disposed at one side of the connection shaft 173. The inclined portion 175 may be disposed at the other side of the connection shaft 173.

The connection shaft 173 may be hanged on the foot connection groove 155A in a vertical direction. Therefore, when a pusher 194 (see FIG. 4) disposed in the inserting groove 171 moves upward and downward, the foot 170 may nod with respect to the connection shaft 173.

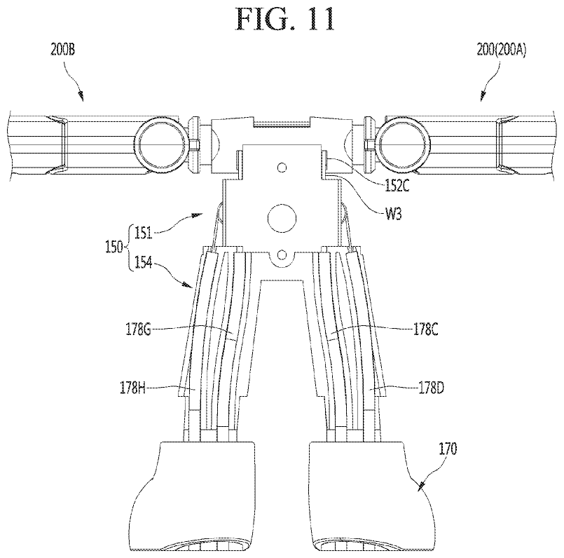

FIG. 10 is a diagram when the inside of a figure according to an embodiment is seen from a front region, and FIG. 11 is a diagram when the inside of a figure according to an embodiment is seen from a rear region.

The figure 100 may include at least one wire W. A material of the wire W may be changed depending on the case. However, the wire W may include a material having high strength, for minimizing a disconnection of the wire W and enhancing the reliability of a product.

The arm assembly 200 may be connected to the seesaw lever 190 (see FIG. 4) embedded into the figure base 180 by using the wire W passing through the tube 178. The one end portion of the seesaw lever 190 may be lowered and may pull the wire W, thereby driving the figure 100.

In more detail, each of the shoulder joint 201 and the elbow joint 202 of the right arm assembly 200A may be connected to the wire W passing through the tube 178 mounted on the left leg frame 154 among the plurality of tubes 178. The left leg frame 154 may be disposed in the left leg 140B (see FIG. 3).

The connector 260 of the right arm assembly 100A may be connected to the wire W passing through the tube 178 mounted on the right leg frame 154 among the plurality of tubes 178. Also, the wire W may be connected to the elastic member 179B mounted on the right leg frame 154. The right leg frame 154 may be disposed in the right leg 140A (see FIG. 3).

Each of the shoulder joint 201 and the elbow joint 202 of the left arm assembly 200B may be connected to the wire W passing through the tube 178 mounted on the right leg frame 154 among the plurality of tubes 178.

The connector 260 of the left arm assembly 100B may be connected to the wire W passing through the tube 178 mounted on the left leg frame 154 among the plurality of tubes 178. Also, the wire W may be connected to the elastic member 179A mounted on the left leg frame 154.

Hereinafter, for convenience of description, the wire W connected to the right arm assembly 200A will be described mainly. Also, since a configuration of the right arm assembly 100A is symmetrical with that of the left arm assembly 100B, those skilled in the art may easily understand a driving method of the left arm assembly 200B.

A first wire W1, a second wire W2, and a third wire W3 may be connected to the arm assembly 200 according to the present embodiment.

The first wire W1 may be connected to the upper arm part 210 or the shoulder joint 201 of the arm assembly 200. The first wire W1 may pull the upper arm part 210 or the first shoulder joint 201 in a direction in which the shoulder joint 201 is bent.

The second wire W2 may be connected to the lower arm part 220 or the elbow joint 202 of the arm assembly 200. The second wire W2 may pull the lower arm part 220 or the elbow joint 202 in a direction in which the elbow joint 202 is bent.

The third wire W3 may be connected to the connector 260 of the arm assembly 200. The third wire W3 may downward pull the connector 260 at a position which is eccentric with respect to a rotational shaft of the connector 260. That is, the third wire W3 may rotate the connector 260 in one direction or the other direction.

That is, the first wire W1 and the second wire W2 may rotate the joints 201 and 202. The third wire W3 may rotate the connector 260. Therefore, each of the first and second wires W1 and W3 may be referred to as a joint wire, and the third wire W3 may be referred to as a connector wire.

The first wire W1 may pass through one tube 178 disposed in a leg opposite to the arm assembly 200. The second wire W2 may pass through the other one tube 178 disposed in the leg opposite to the arm assembly 200. The third wire W3 may pass through one tube 178 disposed in a leg disposed at the same side as the arm assembly 200.

That is, the first wire W1 and the second wire W2 each connected to the right arm assembly 200A may pass through the tube 178 disposed in the left leg frame 154. Also, the third wire W3 connected to the right arm assembly 200A may pass through the tube 178 disposed in the right leg frame 154.

For example, the first wire W1 connected to the right arm assembly 200A may pass through the first tube 178A and may be connected to the shoulder joint 201 or the upper arm part 210. The first wire W1 may be supported in contact with the sub-supporter 157 and the main supporter 158.

The second wire W2 connected to the right arm assembly 200A may pass through the second tube 178B and may be connected to the elbow joint 202 or the lower arm part 220. The second wire W2 may be supported in contact with the sub-supporter 157 and the main supporter 158.

The third wire W3 connected to the right arm assembly 200A may sequentially pass through the third tube 178C, the rear hole 152C, and the front hole 161C (see FIG. 6) and may be connected to the second elastic member 179B. A portion between the rear hole 152C and the front hole 161C may be connected to the connector 260 in a lengthwise direction of the third wire W3.

On the other hand, the first wire W1 and the second wire W2 each connected to the left arm assembly 200B may pass through the tube 178 disposed in the right leg frame 154. Also, the third wire W3 connected to the left arm assembly 200B may pass through the tube 178 disposed in the left leg frame 154.

For example, the first wire W1 connected to the left arm assembly 200B may pass through the sixth tube 178F and may be connected to the shoulder joint 201 or the upper arm part 210. The first wire W1 may be supported in contact with the sub-supporter 157 and the main supporter 158.

The second wire W2 connected to the left arm assembly 200B may pass through the fourth tube 178D and may be connected to the elbow joint 202 or the lower arm part 220. The second wire W2 may be supported in contact with the sub-supporter 157 and the main supporter 158.

The third wire W3 connected to the left arm assembly 200B may sequentially pass through the seventh tube 178G, the rear hole 152C, and the front hole 161C (see FIG. 6) and may be connected to the first elastic member 179A. A portion between the rear hole 152C and the front hole 161C may be connected to the connector 260 in the lengthwise direction of the third wire W3.

The third wire W3 may be connected to the elastic member 179 by a wire connector WG3. However, the third wire W3 may be directly connected to the elastic member 179.

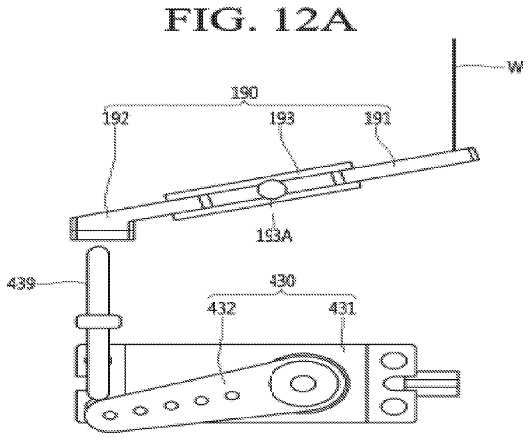

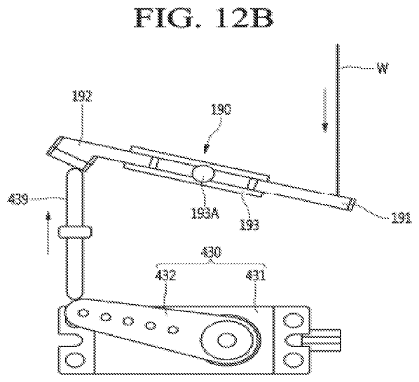

FIGS. 12A and 12B are diagrams for describing an action where a wire according to an embodiment is pulled. In more detail, FIG. 12A is a diagram illustrating a state where a wire is not pulled, and FIG. 12B is a diagram illustrating a state where a wire is pulled downward.

The above-described driving module 400 (see FIG. 2) may include a lift 430 and a load 439.

The lift 430 may be disposed under the figure base 180 (see FIG. 2).

The lift 430 may raise the load 439. In more detail, the lift 430 may include a motor 431 and a lever 432 which is connected to the motor 431 to rotate and to upward pressurize the load 439.

The load 439 may be provided long in a vertical direction. A lower end of the load 439 may be upward pressurized by the lever 432, and an upper end of the load 439 may be upward pressurized by the seesaw lever 190.

As described above, the seesaw lever 190 may be embedded into the figure base 180 (see FIG. 2).

The seesaw lever 190 may include a first lever part 191, a second lever part 192, and a center portion 193.

The wire W may be connected to the first lever 191. The first lever 191 may include one end portion of the seesaw lever 190. The first lever part 191 may extend in one direction from the center portion 193.

The second lever part 192 may be pressurized by the load 439. The second lever 192 may include the other end portion of the seesaw lever 190. The second lever part 192 may extend from the center portion 193 in a direction opposite to the first lever part 191.

The center portion 193 may be disposed between the first lever part 191 and the second lever part 192. The center portion 193 may connect the first lever part 191 to the second lever part 192. A rotational shaft 193A may be provided at the center portion 193. The seesaw lever 190 may rotate about the rotational shaft 193A to operate like seesaw.

When the lift 430 raises the load 439, an upper end of the load 439 may upward pressurize the second lever part 192, and the seesaw lever 190 may rotate about the rotational shaft. That is, the second lever part 192 may be raised, and the first lever part 191 may be lowered. Therefore, the wire W connected to the first lever part 191 may be pulled downward.

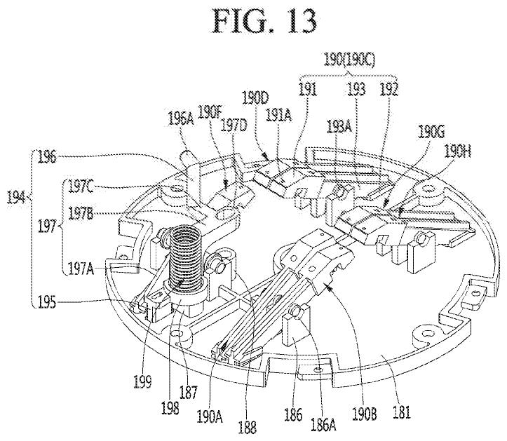

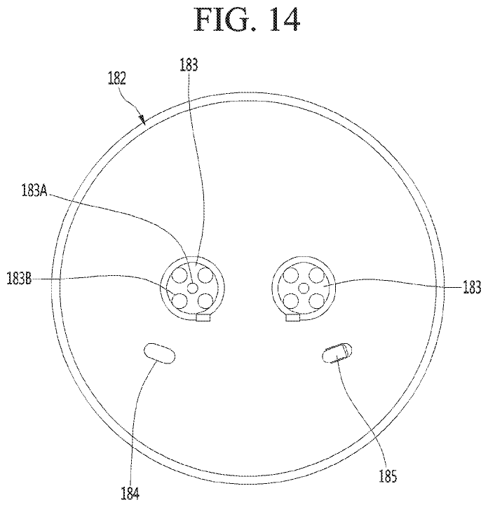

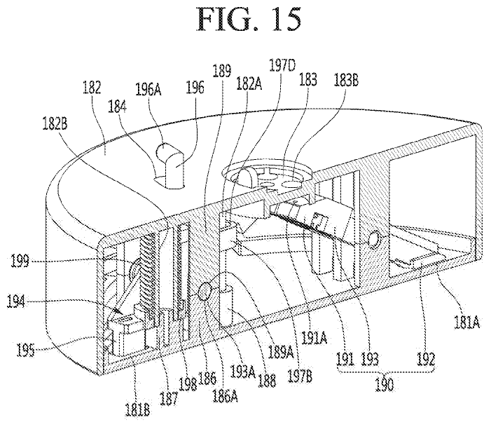

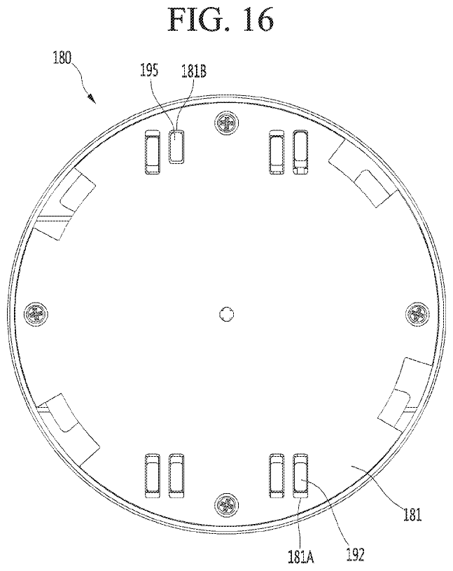

FIG. 13 is a diagram illustrating an example where a base cover is removed from a figure base according to an embodiment. FIG. 14 is a plan view of a base cover according to an embodiment, FIG. 15 is a cross-sectional view illustrating an inner portion of a figure base according to an embodiment, and FIG. 16 is a bottom view of a figure base according to an embodiment.

As described above, a plurality of power transferors 190 and 194 may be provided in a figure base 180.

The plurality of power transferors 190 and 194 may include a first power transferor 190A, a second power transferor 190B, a third power transferor 190C, a fourth power transferor 190D, a fifth power transferor 194, a sixth power transferor 190F, a seventh power transferor 190G, and an eighth power transferor 190H.

The plurality of power transferors 190 and 194 may include at least one of a seesaw lever 190 and a pusher 194. That is, each of the power transferors may be the seesaw lever 190 or the pusher 194. Hereinafter, a case where each of the first power transferor 190A, the second power transferor 190B, the third power transferor 190C, the fourth power transferor 190D, the sixth power transferor 190F, the seventh power transferor 190G, and the eighth power transferor 190H is the seesaw lever 190 and the fifth power transferor 194 is the pusher 194 will be described for example.

A wire W connected to the first power transferor 190A may pass through a first tube 178A. A wire W connected to the second power transferor 190B may pass through a second tube 178B. A wire W connected to the third power transferor 190C may pass through a third tube 178C. A wire W connected to the fourth power transferor 190D may pass through a fourth tube 178D. A wire W connected to the sixth power transferor 190F may pass through a sixth tube 178F. A wire W connected to the seventh power transferor 190G may pass through a seventh tube 178G. A wire W connected to the eighth power transferor 190H may pass through an eighth tube 178H.

That is, the seesaw lever 190 may be provided in plurality. The plurality of seesaw levers 190 may pull different wires W.

Rotational shafts 194 of the plurality of seesaw levers 190 may be parallel to one another. Therefore, different seesaw levers 190 may easily operate in a figure base 180 (see FIG. 2) without interference therebetween.

Some of the plurality of seesaw levers 190 may be connected to a wire W passing through a front region of an inner frame 150, and the other some may be connected to a wire W passing through a rear region of an inner frame 150. A seesaw lever 190 connected to the wire W passing through the front region of an inner frame 150 may be referred to as a front seesaw lever 190A (190B or 190C), and a seesaw lever 190 connected to the wire W passing through the rear region of the inner frame 150 may be referred to as a rear seesaw lever 190C (190D, 190G, or 190H).

A rotational direction in which the front seesaw lever 190A (190B or 190C) pulls a wire W may be opposite to a rotational direction in which the rear seesaw lever 190C (190D, 190G, or 190H) pulls a wire W.

A wire connection hole 191A connected to a wire W may be provided in a first lever part 191 of each seesaw lever 190.

A second lever part 192 may be more adjacent to an outer perimeter of the figure base 180 than the first lever part 191.

A wire W connected to the wire connection hole 191A may pass through a wire through hole 183B provided in a base cover 182 and may enter a tube 178.

A rotational shaft supporting part 186 for rotatably supporting the rotational shaft 193A of the seesaw lever 190 may be provided on a lower plate 181. The rotational shaft supporting part 186 may be provided to protrude from an upper surface to an upper portion of the lower plate 181. A rotational shaft supporting groove 186A where the rotational shaft 193A of the seesaw lever 190 is disposed may be provided at an upper end of the rotational shaft supporting part 186.

A rotational shaft deviation prevention part 189 for preventing the rotational shaft 193A of the seesaw lever 190 from deviating to an upper side may be provided in the base cover 182. The rotational shaft deviation prevention part 189 may be provided to protrude from an upper surface to a lower side of the base cover 182. A rotational shaft cover groove 189A which covers the rotational shaft 193A of the lever 190 at an upper side may be provided in the rotational shaft deviation prevention part 189.

The rotational shaft supporting part 186 may contact the rotational shaft deviation prevention part 189. The rotational shaft supporting groove 186A and the rotational shaft cover groove 189A may communicate with each other and may configure a rotational shaft inserting hole.

The pusher 194 may include a pressurized part 195, a pressurizer 196, and a connection part 197.

The pressurized part 195 may be upward pressurized by a load 439. A load 439 for driving the pressurizer 195 may differ from a load 439 for driving the seesaw lever 190.

The pressurized part 195 may be more adjacent to an outer perimeter of the figure base 180 than the pressurizer 196.

The pressurizer 196 may upward pressurize the foot 170. The pressurizer 196 may be provided long in a vertical direction.

The pressurizer 196 may pass through an upper surface of the figure base 180 and may be inserted into an inserting groove 171 (see FIG. 8) provided in the foot 170. In more detail, an upper end portion of the pressurizer 196 may be bent to form a bending portion 196A, and the bending portion 196A may pass through a through hole 184 provided in the upper surface of the figure base 180 and may be inserted into the inserting groove 171 of the foot 170.

The connection part 197 may connect the pressurized part 195 to the pressurizer 196. The connection part 197 may be provided to be inclined in a direction in which a height increases in a direction from the pressurized part 195 to the pressurizer 196.

In more detail, the connection part 197 may include an inclined portion 197A, an extension portion 197B extending from an end portion of the inclined portion 197A, and a protrusion portion 197C protruding from the extension portion 197B.

The inclined portion 197A may be connected to the pressurized part 195. The inclined portion 197A may have a height which increases in a direction distancing from the pressurized part 195.

The extension portion 197B may horizontally extend from the end portion of the inclined portion 197A. A guide hole 197D may be provided in the extension portion 197B. The guide hole 197D may be a long hole which is provided long in a lengthwise direction of the extension portion 197B. A pusher guide part 182A vertically protruding from an inner surface of the figure base 180 may be inserted into the guide hole 197D. Therefore, the pusher 194 may be guided by the guide part 182A and may move upward and downward.

The pusher guide part 182A may downward protrude from the base cover 182. In this case, a first fastening part 188 fastened to the pusher guide part 182 may be provided on the lower plate 181. Alternatively, the pusher guide part 182A may upward protrude from the lower plate 181, and the first fastening part 188 may be provided in the base cover 182.

The protrusion portion 197C may laterally protrude from the extension portion 197B in the lengthwise direction of the extension portion 197B. That is, a protrusion direction of the protrusion portion 197C may be vertical to the lengthwise direction of the extension portion 197B. The protrusion portion 197C may be connected to the pressurizer 196. In more detail, the pressurizer 196 may be provided to long protrude from the protrusion portion 197C to an upper side.

An inner elastic member 199 may provide a downward elastic force to the pusher 194. The inner elastic member 199 may be a coil spring.

An elastic member pressurizer 198 for pressurizing the inner elastic member 199 at a lower side may be provided in the pusher 194. The elastic member pressurizer 198 may be provided at a side portion of the inclined 197C of the connection part 197.

The inner elastic member 199 may surround an outer perimeter of the elastic member supporting part 182B which protrudes from an inner surface of the figure base 180.

The elastic member supporting part 182B may have an approximately hollow cylindrical shape. The elastic member supporting part 182B may be provided to downward protrude from the base cover 182. In this case, a second fastening part 187 fastened to the elastic member supporting part 182B may be provided on the lower plate 181.

Moreover, the elastic member supporting part 182B may pass through the elastic member pressurizer 198 and may be fastened to the second fastening part 187. Therefore, the elastic member supporting part 182B may support the inner elastic member 199, and moreover, may guide the vertical movement of the pusher 194.

Hereinafter, an action of the pusher 197 will be described.

When a load 439 (see FIGS. 12A and 12B) upward pressurizes the pressurized part 195 of the pusher 197, the pusher 197 may be raised. A raising operation of the pusher 197 may be guided by the pusher guide part 182A and the elastic member supporting part 182B.

When the pusher 197 is raised, the pressurizer 196 may upward pressurize the foot 170 with being inserted into the inserting groove 171 of the foot 170. Accordingly, a front portion of the foot 170 may be raised. In this case, the inclined portion 175 (see FIG. 3) provided on a lower surface of the foot 170 may get close to and contact the upper surface of the figure base 180. Also, the inner elastic member 199 may be compressed between the elastic member pressurizer 198 and the upper surface of the figure base 180.

When the load 439 (see FIGS. 12A and 12B) does not upward pressurize the pressurized part 195 of the pusher 194, the inner elastic member 199 may extend based on a restoring force and may downward push the elastic member pressurizer 198. Accordingly, the pusher 194 may be lowered.

When the pusher 194 is lowered, the pressurizer 196 may be lowered with being inserted into the inserting groove 171, and the front portion of the foot 170 may be lowered. In this case, the inclined portion 175 (see FIG. 3) provided on the lower surface of the foot 170 may distance from the upper surface of the figure base 180.

Referring to FIG. 14, a fastening groove 183 provided in a base cover 182 may be provided as a pair of fastening grooves 183 which are apart from each other. A base fastening part 156 provided in a pair of leg frames 154 (see FIG. 5) may be respectively inserted into the pair of fastening grooves 183.

The fastening groove 183 may be provided to be stepped from an upper surface of the base cover 182 at least once.

A frame fastening hole 183A corresponding to a base fastening hole 156A (see FIG. 8) provided in the base fastening part 156 may be provided in the base cover 282.

The frame fastening hole 183A may be provided in the fastening groove 183. For example, the frame fastening hole 183A may be provided in order for a center portion of the fastening groove 183 to vertically pass through the frame fastening hole 183A. A fastening member such as a screw may pass through the frame fastening hole 183A and may be fastened to a base fastening hole 156A provided in the base fastening part 156. Accordingly, an inner frame 150 may be solidly fastened to the base cover 182.

A wire through hole 183B through which a wire W connected to a first lever part 191 of a seesaw lever 190 passes may be provided in the base cover 182. The wire through hole 183B may be provided in the fastening groove 183. A plurality of wire through holes 183B may be provided in respective fastening grooves 183, and wires W may pass through different wire through holes 183B.

The wire through hole 183B may be disposed on the first lever part 191 of the seesaw lever 190. In more detail, the wire through hole 183B may vertically overlap a wire connection hole 191A provided in the first lever part 191.

Moreover, a through hole 184 through which a pressurizer 196 of a pusher 194 passes may be provided in the base cover 182. The through hole 184 may be provided to pass through the upper surface of the base cover 182. The through hole 184 may be disposed more forward than the fastening groove 183. The through hole 184 may have a size and a shape which enable a bending portion 196A of the pressurizer 196 to pass through the through hole 184.

Moreover, when at least one of both feet of a figure 100 is not driven, a foot fixing part 185 for fixing a foot 170 may be provided in the base cover 182. The foot fixing part 185 may protrude from the upper surface of the base cover 182 and may be inserted into an inserting groove 170A (see FIG. 8) of the foot 170.

The foot fixing part 185 may be disposed more forward than the fastening groove 183. The foot fixing part 185 may be disposed at a side portion of the through hole 184.

For example, a right foot 170 of the figure 100 may perform a nodding operation, and a left foot 170 thereof may be fixed. In this case, the pressurizer 196 of the pusher 194 may be inserted into an inserting groove 170A provided in the right foot 170, and a foot fixing part 185 may be inserted into an inserting groove 170A provided in the left foot 170.

Referring to FIG. 16, a plurality of load through holes 181A and 181B through which a load 439 (see FIGS. 12A and 12B) of a driving module 400 (see FIG. 2) passes may be provided in a lower plate 181 of a figure base 180.

The load through holes 181A and 181B may be provided to vertically pass through the lower plate 181. The load through holes 181A and 181B may be provided in plurality. A plurality of loads 439 may pass through different load through holes 181A and 181B.

The plurality of load through holes 181A and 181B may be adjacent to an outer perimeter of the figure base 180. That is, the plurality of load through holes 181A and 181B may be provided to be adjacent to an edge of the lower plate 181.

The plurality of load through holes 181A and 181B may include a first load through hole 181A, through which a load 439 for pressurizing a second lever part 192 of a seesaw lever 190 passes, and a second load through hole 181B through which a load 439 for pressurizing a pressurized part 195 of a pusher 194 passes. For example, seven first load through holes 181A and one second load through hole 181B may be provided in the lower plate 181.

The second lever part 192 of each seesaw lever 190 may be disposed in the first load through hole 181A, or may be disposed on the first load through hole 181A. The pressurized part 195 of the pusher 194 may be disposed in the second load through hole 181B, or may be disposed on the second load through hole 181B.

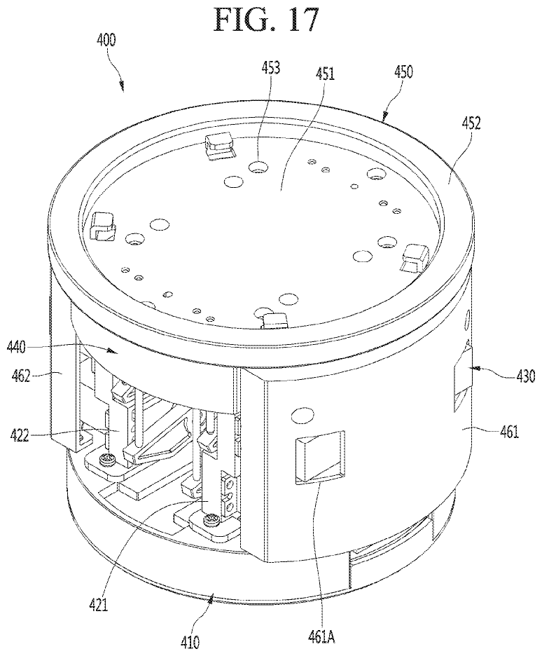

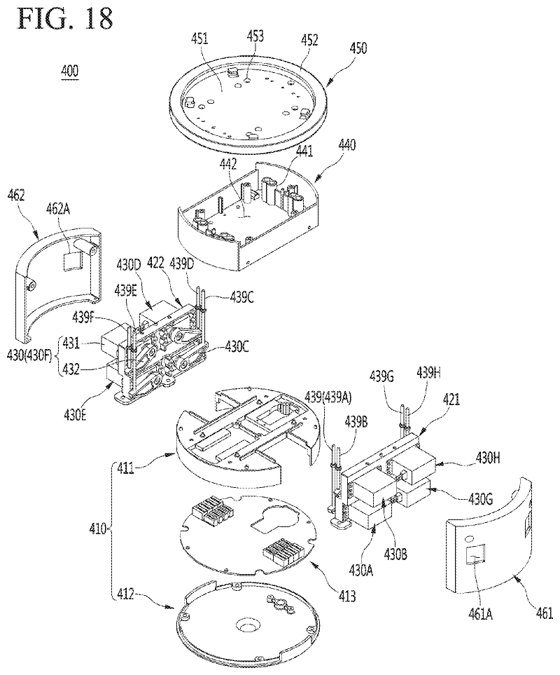

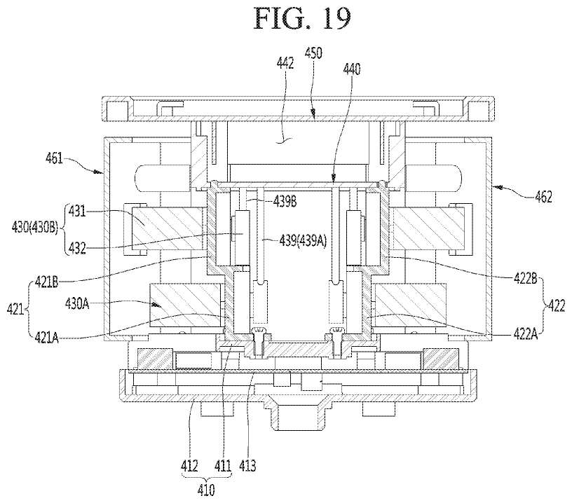

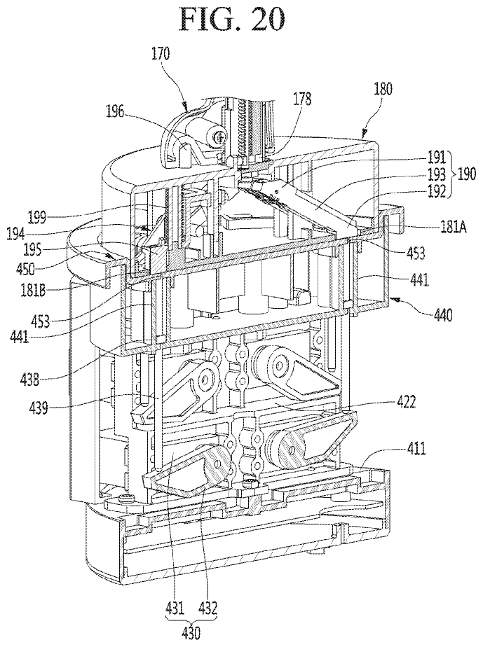

FIG. 17 is a perspective view of a driving module according to an embodiment, FIG. 18 is an exploded perspective view of a driving module according to an embodiment. FIG. 19 is a cross-sectional view illustrating an inner portion of a driving module according to an embodiment, and FIG. 20 is a cut perspective view for describing a driving mechanism pulling a wire according to an embodiment.

A driving module 400 may include a driving base 410, a lifter 430, a plurality of mounters 421 and 422, a load 439, an upper body 440, and a top cover 450. The driving module 400 may further include a plurality of sidewalls 461 and 462.

The driving base 410 may configure a lower surface of the driving module 400. The driving base 410 may include a lower plate 412 and a base cover 411 which covers the lower plate 412 at an upper side.

A substrate 413 may be embedded into the driving base 410. The substrate 413 may be disposed between the lower plate 412 and the base cover 411. The substrate 413 may include a controller which controls the lifter 430.

As described above, the lifter 430 may raise the load 430. The load 439 may be provided long in a vertical direction. The load 439 may upward pressure a power transferor 190.

The lifter 430 may include a motor 431 and a lever 432 which is connected to the motor 431 to rotate and upward pressurizes the load 439.

Each of the lifter 430 and the load 439 may be provided in plurality. The plurality of lifters 430 may include a first lifter 430A which raises a first load 439A, a second lifter 430B which raises a second load 439B, a third lifter 430C which raises a third load 439C, a fourth lifter 430D which raises a fourth load 439D, a fifth lifter 430E which raises a fifth load 439E, a sixth lifter 430F which raises a sixth load 439F, a seventh lifter 430G which raises a seventh load 439G, and an eighth lifter 430H which raises an eighth load 439H.

The first load 439A may upward pressurize a first power transferor 190A (see FIG. 13). The second load 439B may upward pressurize a second power transferor 190B. The third load 439C may upward pressurize a third power transferor 190C. The fourth load 439D may upward pressurize a fourth power transferor 190D. The fifth load 439E may upward pressurize a fifth power transferor 190E. The sixth load 439F may upward pressurize a sixth power transferor 190F. The seventh load 439G may upward pressurize a seventh power transferor 190G. The eighth load 439H may upward pressurize an eighth power transferor 190H.

The lifter 430 may be mounted on the mounters 421 and 422. In more detail, the motor 431 may be mounted on the mounters 421 and 422.

The mounters 421 and 422 may be disposed on the driving base 410. The mounters 421 and 422 may be supported by the driving base 410.

The mounters 421 and 422 may be provided as a pair of mounters facing each other. The pair of mounters 421 and 422 may be apart from each other in a horizontal direction.

The pair of mounters 421 and 422 may include a first mounter 421 with some of a plurality of lifters 430 mounted thereon and a second mounter 422 with the other some lifters 430 mounted thereon.

For example, the first lifter 430A, the second lifter 430B, the seventh lifter 430G, and the eighth lifter 430H may be mounted on the first mounter 421. The third lifter 430C, the fourth lifter 430D, the fifth lifter 430E, and the sixth lifter 430F may be mounted on the second mounter 422.

Each lever 432 and load 439 may be disposed between the pair of mounters 421 and 422. That is, the lever 432 and the load 439 may be disposed more inward than the mounters 421 and 422. On the other hand, the motor 431 may be disposed to protrude from each of the mounters 421 and 422 to an outer side. The mounter 421 may include a lower mounting part 421A and an upper mounting part 421B disposed on the lower mounting part 421A, and the mounter 422 may include a lower mounting part 422A and an upper mounting part 422B disposed on the lower mounting part 422A. The upper mounting part 421B may be provide to be stepped from the lower mounting part 421A in a horizontal outward direction, and the upper mounting part 422B may be provide to be stepped from the lower mounting part 422A in a horizontal outward direction.

The first mounter 421 may include a first lower mounting part 421A and a second upper mounting part 421B. The second mounter 422 may include a second lower mounting part 422A and a second upper mounting part 422B. A horizontal distance between the first lower mounting part 421A and the second lower mounting part 422A may be shorter than a horizontal distance between the first upper mounting part 421B and the second upper mounting part 422B.

A lever 432 of a lifter 430 mounted on the lower mounting parts 421A and 422A may not vertically overlap a lever 432 of a lifter 430 mounted on the upper mounting parts 421B and 422B.

A load 439 raised by the lifter 430 mounted on the lower mounting parts 421A and 422A may be disposed more inward than a load 439 raised by the lifter 430 mounted on the upper mounting parts 421B and 422B. A height of the load 439 raised by the lifter 430 mounted on the lower mounting parts 421A and 422A may be higher than that of the load 439 raised by the lifter 430 mounted on the upper mounting parts 421B and 422B.

For convenience, the first lifter 430A and the second lifter 430B will be mainly described. The first lifter 430A may be mounted on the lower mounting part 421A, and the second lifter 430B may be mounted on the upper mounting part 421B. The lower mounting part 421A and the upper mounting part 421B may be provided to be stepped in a horizontal direction, and thus, a lever 432 of the first lifter 430A may not overlap a lever 432 of the second lifter 430B in a vertical direction. Accordingly, the lever 432 of the first lifter 430A and the lever 432 of the second lifter 430B may smoothly rotate without interference therebetween. Also, the first load 439A may be disposed more inward than the second load 439B. A height of the first load 439A may be higher than that of the second load 439B.

Sidewalls 461 and 462 may surround the mounters 421 and 422 at an outer side. The sidewalls 461 and 462 may protect the lifter 430 (in more detail, the motor 431).

The sidewalls 461 and 462 may be provided as a pair of sidewalls which are apart from each other in a horizontal direction. The pair of sidewalls 461 and 462 may include a first sidewall 461 disposed outside the first mounter 421 and a second sidewall 462 disposed outside the second mounter 422.

Avoidance holes 461A and 462A for preventing interference with the motor 431 (in more detail, the motor 431 mounted on the upper mounting parts 421B and 422B) may be provided in the sidewalls 461 and 462. In more detail, a first avoidance hole 461A for preventing interference with the motor 431 mounted on the upper mounting part 421B may be provided in the sidewall 461. A second avoidance hole 462A for preventing interference with the motor 431 mounted on the upper mounting part 422B may be provided in the sidewall 462.

An upper body 440 may be disposed on the mounters 421 and 422. The upper body 440 may have a shape where an upper surface thereof is opened.

An internal space 442 may be provided in the upper body 440. A sensor (not shown) for sensing the mounting or not of a figure module 10 (see FIG. 2) may be disposed in the internal space 442.

A load guide part 441 for vertically guiding the load 439 may be provided in the upper body 440. The load guide part 441 may be a hollow portion which protrudes from a lower surface of the upper body 440 to the internal space 442. The load 430 may pass through the load guide part 441.

A stopper 438 may be provided in the load 439. The stopper 438 may be provided to extend in a radius outward direction from an outer perimeter of the load 439. The stopper 438 may be disposed in the load guide part 441. When the load 439 is lowered, the stopper 438 may be hanged on a lower end of the load guide part 441. Accordingly, lowering of the load 439 may stop.

A top cover 450 may be disposed on the upper body 440. The top cover 450 may cover the internal space 442 of the upper body 440 at an upper side. A figure base 180 (see FIG. 2) may be detachably fastened to the top cover 450.

The top cover 450 may include a cover body 451 and an edge portion 452. The cover body 451 may have a discal shape, and the edge portion 452 may have a circular ring shape. The cover body 451 may be disposed under the figure base 180. The edge portion 452 may be provided at an edge of the cover body 451. The edge portion 452 may be provided to be upward stepped from the cover body 451. The edge portion 452 may surround a lower portion of an outer perimeter of the figure base 180.

A cover through hole 453 through which the load 439 passes may be provided in the top cover 450. In more detail, the cover through hole 453 may be provided in the cover body 451.

The cover through hole 453 may be disposed on the load guide part 441 and may be disposed under load through holes 181A and 181B provided in a lower surface of the figure base 180. Accordingly, the load 439 may sequentially pass through the cover through hole 453 and the load through holes 181A and 181B and may upward pressurize power transferors 190 and 194.

A load 439 through which a first load through hole 181A may upward pressurize a second lever part 192 of a seesaw lever 190, and a first lever part 191 may be lowered. Therefore, a wire W which is connected to the first lever part 191 to pass through an inner portion of a tube 178 may be pulled.

A load 439 through which a second load through hole 181B may upward pressurize a pressurized part 195 of a pusher 194. Therefore, an elastic member 199 may be compressed, and a pressurizer 196 may be raised, thereby upward pushing a foot 170.

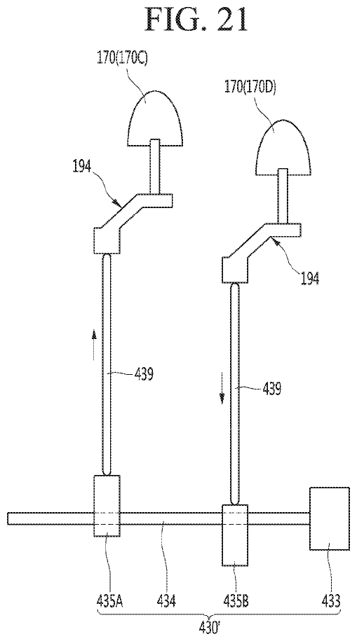

FIG. 21 is a diagram for describing an action where a pusher according to another embodiment is pressurized upward.

A configuration where a load 439 for pressurizing a pusher 194 is raised, according to the present embodiment, may differ from the above-described embodiment. Also, the present embodiment may have a feature where a motion where all of both feet 170 nod is capable of being performed. Therefore, a repetitive description is omitted, and a difference will be mainly described.

In the present embodiment, both feet 170 may move, and each of the both feet 170 may be a movable part.

The above-described driving module 400 (see FIG. 2) may include a driving source 430′ which simultaneously drive the both feet 170. The driving source 430′ may be disposed under a figure base 180 (see FIG. 2).

The driving source 430′ may raise a plurality of loads 439 which upward pressurize a plurality of pushers 194.

In more detail, the driving source 430′ may include a motor 433, a horizontal shaft 434, and a plurality of cams 435A and 435B.

The motor 433 may be disposed under the figure base 180.

The horizontal shaft 434 may be disposed long in a horizontal direction. The horizontal shaft 434 may be connected to the motor 433 to rotate.

The plurality of cams 435A and 435B may be fastened to the horizontal shaft 434. The plurality of cams 435A and 435B may be apart from each other in a horizontal direction.

The plurality of cams 435A and 435B may include a first cam 435A and a second cam 435B. A load 439 raised by the first cam 435A may upward pressurize a pusher 194 which pushes one foot 170C of the both feet 170. A load 439 raised by the second cam 435B may upward pressurize a pusher 194 which pushes the other foot 170D of the both feet 170.

The first cam 435A and the second cam 435B may raise the load 439 at different timings. That is, a fastening direction in which the first cam 435A is fastened to the horizontal shaft 434 may not match a fastening direction in which the second cam 435B is fastened to the horizontal shaft 434.

Therefore, wen some of a plurality of loads 439 are raised, the other some thereof may be lowered.

For example, when the horizontal shaft 434 rotates by 180 degrees, the first cam 435A may upward pressurize a load 439 disposed on the first cam 435A, and the second cam 435B may not pressurize a load 439 disposed on the second cam 435B. Therefore, the load 439 disposed on the second cam 435B may be lowered by an elastic force of an inner elastic member 199 (see FIG. 20). On the other hand, when the horizontal shaft 434 rotates by 360 degrees, the second cam 435B may upward pressurize the load 439 disposed on the second cam 435B, and the first cam 435A may not pressurize the load 439 disposed on the first cam 435A. Therefore, the load 439 disposed on the first cam 435A may be lowered by the elastic force of the inner elastic member 199 (see FIG. 20).

Therefore, the both feet 180 may be simultaneously driven by a single motor 433. Also, directions in which the plurality of cams 435A and 435B are fastened to the horizontal shaft 434 may be differently adjusted, and a motion where the both feet 1700 nod at different timings may be implemented.

According to an embodiment, a load raised by a lifter may pressurize a pusher embedded into a figure base, and the pusher may upward push a movable part disposed on the figure base. Also, an elastic member embedded into a figure base may apply a downward elastic force to the pusher. Accordingly, a motion where the movable part nods with respect to the figure base may be implemented.

Moreover, a pressurized part may be more adjacent to an outer perimeter of the figure base. Accordingly, a load which upward pressurizes the pressurized part may be easily disposed in a driving module so as not to interfere with another load.

Moreover, a connection part may have a height which increases in a direction from the pressurized part to a pressurizer. Accordingly, a raising operation of a load may be smoothly changed to movement of the movable part.

Moreover, a guide hole through which a pusher guide part protruding from the figure base passes may be provided in an extension portion of the connection part. Accordingly, raising or lowering of the pusher may be guided in the figure base.

Moreover, an elastic member pressuring part may be provided at an inclined portion. Accordingly, an elastic member may be sufficiently compressed between an inner upper surface of the figure base and the elastic member pressuring part.

Moreover, the elastic member may surround an outer perimeter of the elastic member supporting part. Accordingly, an elastic member supporting part may support the elastic member in a horizontal direction.

Moreover, the elastic member supporting part may pass through the elastic member pressurizing part. Accordingly, the elastic member pressurizing part may smoothly pressurize the elastic member without interfering with the elastic member supporting part.

Moreover, a load through hole through which a load passes may be provided in a lower surface of the figure base. Accordingly, the load may easily pressurize the pusher disposed in the figure base.

Moreover, a through hole through which a pressurizing part of the pusher passes may be provided in an upper surface of the figure base. Accordingly, the pressurizing part may easily pressurize the movable part disposed on the figure base.

Moreover, the figure base may include a lower plate and a base cover. Accordingly, the pusher may be easily embedded into the figure base.

Moreover, the figure may include an inner frame which is disposed in a body and is connected to the movable part. Accordingly, when an action robot is seen from an outer side, the body and the movable part may be seen like being connected to each other, and thus, an external appearance of the action robot may be enhanced.

Moreover, a connection shaft rotatably connected to the inner frame may be provided in the movable part. Accordingly, the movable part may nod with respect to the connection shaft.

Moreover, an inserting groove into which the pressurizing part of the pusher is inserted may be provided in the movable part. Accordingly, the pusher may reliably push the movable part, and moreover, a degree to which the pressurizing part of the pusher is externally exposed may be minimized.

Moreover, an inclined portion apart from an upper surface of the figure base may be provided on a lower surface of the movable part. Accordingly, the movable part may smoothly nod with respect to the upper surface of the figure base.

According to another embodiment, a plurality of cams fastened to a horizontal shaft may respectively and upward pressurize a plurality of loads, and the plurality of loads may respectively and upward pressurize a plurality of pushers. Accordingly, a plurality of movable parts may be simultaneously driven.

Moreover, the plurality of cams may be fastened to a horizontal shaft in different directions. Accordingly, the plurality of movable parts may be driven at different timings.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the appended claims and their equivalents.

What is claimed is:

1. An action robot comprising:
a figure including at least one movable part;
a figure base configured to support the at least one movable part at a lower side;
a pusher embedded in the figure base and passing through an upper surface of the figure base, the pusher being configured to push the at least one movable part in a first direction;
an elastic member configured to provide an elastic force to the pusher in a downward direction different from the first direction;
a lifter disposed under the figure base; and
a load member configured to be raised by the lifter to pressurize the pusher in the first direction.

2. The action robot of claim 1, wherein the pusher comprises:
a pressurized part configured to be pressurized in the first direction by the load member;
a pressurizer configured to push the at least one movable part in the first direction; and
a connection part connecting the pressurized part to the pressurizer.

3. The action robot of claim 2, wherein the pressurized part is closer to an outer perimeter of the figure base than the pressurizer.

4. The action robot of claim 2, wherein the connection part is inclined in the first direction from the pressurized part to the pressurizer.

5. The action robot of claim 2, wherein the connection part comprises:
an inclined portion connected to the pressurized part, the inclined portion being inclined in an upward direction from the pressurized part;
an extension portion horizontally extending from an end portion of the inclined portion; and
a protrusion portion connected to the pressurizer and laterally protruding from the extension portion.

6. The action robot of claim 5, further comprising a pusher guide part vertically protruding from an inner surface of the figure base,
wherein a guide hole is provided in the extension portion of the connection part, and
wherein the pusher guide part passes through the guide hole.

7. The action robot of claim 5, further comprising an elastic member pressurizer configured to pressurize the elastic member in the first direction,
wherein the elastic member pressurizer is provided at a side portion of the inclined portion of the connection part.

8. The action robot of claim 7, further comprising an elastic member supporting part provided in the figure base,
wherein the elastic member supporting part vertically protrudes from an inner surface of the figure base, and
wherein the elastic member surrounds an outer perimeter of the elastic member supporting part.

9. The action robot of claim 8, wherein the elastic member supporting part passes through the elastic member pressurizer.

10. The action robot of claim 1, wherein a lower surface of the figure base is provided with a load member through hole, and
wherein the load member passes through the load member through hole.

11. The action robot of claim 2, wherein a top surface of the figure base is provided with a through hole, and
wherein the pressurizer passes through the through hole of the top surface of the figure base.

12. The action robot of claim 2, wherein the figure base comprises:
a lower plate disposed under the pusher; and
a base cover covering the lower plate and covering the pusher.

13. The action robot of claim 1, wherein the figure comprises:
a body, and
an inner frame disposed in the body and connected to the at least one movable part.

14. The action robot of claim 13, further comprising a connection shaft rotatably connected to the inner frame and provided in the at least one movable part.

15. The action robot of claim 14, wherein an inserting groove is provided in the at least one movable part,
wherein the inserting groove is disposed at a first side of the connection shaft and is recessed upwards from a lower surface of the at least one movable part, and
wherein a portion of the pusher is inserted into the inserting groove.

16. The action robot of claim 15, wherein the lower surface of the at least one movable part contacts the upper surface of the figure base,
wherein the at least one movable part includes an inclined portion disposed at a second side of the connection shaft and on the lower surface of the at least one movable part, and
wherein the inclined portion of the at least one movable part is spaced apart from the upper surface of the figure base.

17. An action robot comprising:
a figure including a plurality of movable parts;
a figure base supporting the plurality of movable parts at a lower side of the plurality of movable parts;
a plurality of pushers embedded in the figure base and passing through an upper surface of the figure base, each pusher being configured to push a respective one of the plurality of movable parts in a first direction;
a motor disposed under the figure base;
a horizontal shaft disposed under the figure base and connected to the motor;
a plurality of cams connected to the horizontal shaft; and
a plurality of load members,
wherein each cam among the plurality of cams is configured to move a respective load member among the plurality of load members to push a respective pusher of the plurality of pushers in the first direction.

18. The action robot of claim 17, wherein the plurality of cams extends from the horizontal shaft in different directions.

19. The action robot of claim 17, wherein each pusher comprises:
a pressurized part pressurized in the first direction by the respective load member of the plurality of load members;
a pressurizer configured to push the respective movable part of the plurality of movable parts in the first direction; and
a connection part configured to connect the pressurized part to the pressurizer.

20. The action robot of claim 19, wherein the respective pressurized part is closer to an outer perimeter of the figure base than the respective pressurizer.
